(19) United States
(12) Patent Application Publication
(10) Pub. No.: US 2017/0049263 A1
(43) Pub. Date: Feb. 23, 2017

(54) ELECTRIC MILLING MACHINE

(71) Applicant: Sharp Kabushiki Kaisha, Sakai-shi, Osaka (JP)

(72) Inventors: Aya CHIBA, Sakai-shi (JP); Keisuke MORISHITA, Sakai-shi (JP); Minoru TANAKA, Sakai-shi (JP); Masaya UCHIYAMA, Sakai-shi (JP)

(21) Appl. No.: 15/119,766

(22) PCT Filed: Apr. 22, 2015
(86) PCT No.: PCT/JP2015/062217

§ 371 Date: Aug. 18, 2016

(30) Foreign Application Priority Data
Apr. 24, 2014 (JP) 2014-090310

(51) Int. Cl. A47J 31/42; A23F 3/12; A47J 42/20

(52) U.S. Cl. CPC A47J 31/42; A47J 42/20; A23F 3/12

(57) ABSTRACT

In an electric milling machine, when a milling operation is completed, a “milling prohibition timer” is set. With the timer being set, the electric milling machine does not perform a milling operation until countdown of the timer ends and the timer is cleared even though the electric milling machine is instructed to perform the milling operation. Even when supply of electric power from an external power supply to the electric milling machine is stopped, countdown of the timer is continued by using electric power supplied from an auxiliary power supply within the electric milling machine.

### TECHNICAL FIELD

The present disclosure relates to an electric milling machine, and particular to an electric milling machine which grates food by relatively moving two or more members which abut to each other.

### BACKGROUND ART

Japanese Patent Laying-Open No. 2005-199242 (PTD 1) has conventionally proposed various techniques for an apparatus for preparing a beverage by making use of a grating mechanism obtaining a grated object by finely grating food with rotation of a mill.

### CITATION LIST

### Patent Document

### PTD 1: Japanese Patent Laying-Open No. 2005-199242

### SUMMARY OF INVENTION

### Technical Problem

When an electric milling machine which grates food by relatively operating members joined to each other, such as the grating mechanism including the mill above, grates food continuously for a long period of time, an operating portion is expected to be high in temperature due to friction. Therefore, measures for avoiding too high a temperature in the portion of the electric milling machine are preferably taken.

The present disclosure was made in view of such circumstances, and an object thereof is to provide an electric milling machine in which increase in temperature of a grating mechanism can be suppressed.

### Solution to Problem

According to one aspect, an electric milling machine for grating food is provided, the electric milling machine including a grating mechanism for producing powders of food by grating food by relatively moving two or more members which abut to each other and a control unit configured to control an operation of the grating mechanism, and the control unit being configured to perform processing for making transition to a grating prohibition mode for prohibiting an operation for grating the food by the grating mechanism after grating of the food by the grating mechanism and prohibiting the grating operation by the grating mechanism until a prescribed condition is satisfied.

Preferably, the prescribed condition includes lapse of a prescribed period of time.

Preferably, the control unit is configured to be supplied with electric power from an external power supply, the electric milling machine further includes an internal power supply for supplying electric power to the control unit when supply of electric power from the external power supply is cut off, and the control unit is configured to execute a grating control mode with electric power supplied from the internal power supply when supply of electric power from the external power supply is cut off.

Preferably, the control unit is configured to set the prescribed condition based on a manner of grating of the food by the grating mechanism.

Preferably, the electric milling machine further includes a first oscillation circuit for oscillating a clock with electric power supplied from the external power supply, a second oscillation circuit for oscillating a clock with electric power supplied from the internal power supply, and storage means for storing information for correcting the clock from the second oscillation circuit based on the clock from the first oscillation circuit, and the control unit is configured to correct the clock emitted from the second oscillation circuit with the information and to use the corrected clock when the control unit performs the processing with electric power supplied from the internal power supply.

### ADVANTAGEOUS EFFECTS OF INVENTION

According to the present disclosure, the electric milling machine can make transition to a grating prohibition mode for prohibiting an operation for grating food by the grating mechanism. Thus, continued increase in temperature of the grating mechanism due to a continued operation for grating food by the grating mechanism can be avoided.

### BRIEF DESCRIPTION OF DRAWINGS

FIG. 1 is an overall perspective view of a beverage preparation apparatus in a first embodiment.

FIG. 2 is a cross-sectional view along the line II-II in FIG. 1.

FIG. 3 is an overall perspective view showing a schematic component of the beverage preparation apparatus in the first embodiment.

FIG. 4 shows a first preparation flow showing discharge of Japanese tea using the beverage preparation apparatus in the first embodiment.

FIG. 5 shows a second preparation flow showing discharge of Japanese tea using the beverage preparation apparatus in the first embodiment.

FIG. 6 shows a third preparation flow showing discharge of Japanese tea using the beverage preparation apparatus in the first embodiment.

FIG. 7 is a perspective view showing only an internal structure of the beverage preparation apparatus in the first embodiment.

FIG. 8 is an enlarged view of a structure around a milling motor unit.

FIG. 9 is a perspective view of a milling unit in the first embodiment.

FIG. 10 is an exploded perspective view of the milling unit in the first embodiment.

FIG. 11 is a vertical cross-sectional view of the milling unit in the first embodiment.

FIG. 12 is a perspective view of an agitation unit in the present first embodiment.

FIG. 13 is a vertical cross-sectional view of the agitation unit in the first embodiment.

FIG. 14 is a diagram showing one example of a hardware configuration of the beverage preparation apparatus in the first embodiment.

FIG. 15 is a flowchart of one example of processing performed in a beverage preparation apparatus 1 for preparation of a beverage.

FIG. 16 is a flowchart of processing performed in beverage preparation apparatus 1 for countdown and reset of a milling prohibition timer.

FIG. 17 is a diagram schematically showing clocks from three types of clock oscillation circuits.

FIG. 18 is a diagram showing a specific example of a configuration of a central processing unit (CPU) and an external clock in a control device as well as peripheral devices thereof.

### DESCRIPTION OF EMBODIMENTS

A beverage preparation apparatus representing an embodiment of an electric milling machine in the present disclosure will be described with reference to the drawings. The beverage preparation apparatus includes a grating mechanism for producing powders of food by grating the food and a heating mechanism for heating a liquid for preparing a beverage by mixing the liquid with the powders produced by the grating mechanism. The electric milling machine, however, should only include at least a grating mechanism and does not have to include a heating mechanism

In the drawings of embodiments described below, the same or corresponding elements have the same reference numerals allotted and redundant description may not be repeated. When the number or an amount is mentioned in each embodiment, the scope of the present invention is not necessarily limited to the number or the amount unless otherwise specified.

### First Embodiment

In a first embodiment, though a case that tea leaves are used as an object to be grated and tea is prepared as a beverage will be described by way of example, the object to be grated is not limited to tea leaves, but the first embodiment can also be applied to preparation of a beverage with cereals, dried goods, and other objects to be grated.

Hereinafter, tea leaves mean a solid state before grating, powder tea leaves mean grated tea leaves, and tea means a beverage obtained by agitating (mixing) powder tea leaves and hot water.

(Beverage Preparation Apparatus 1)

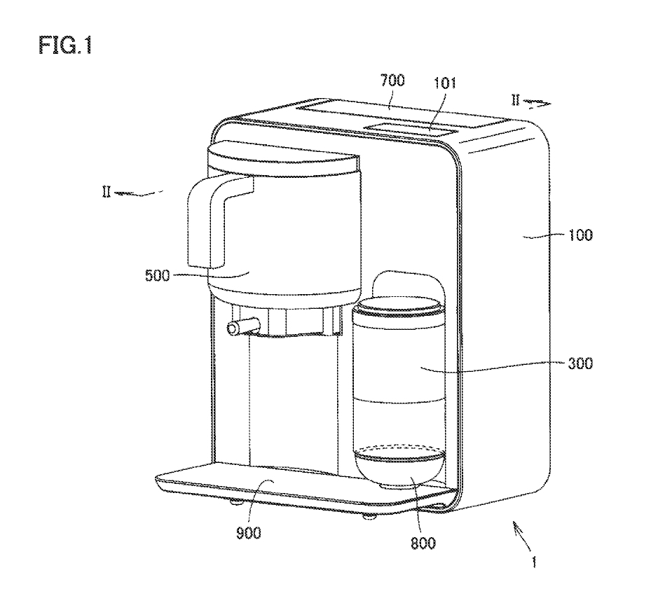

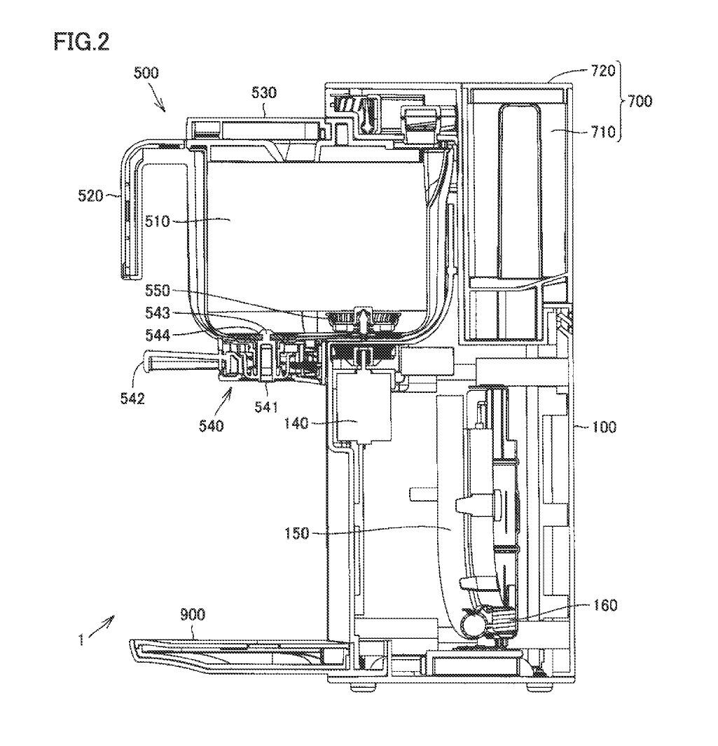

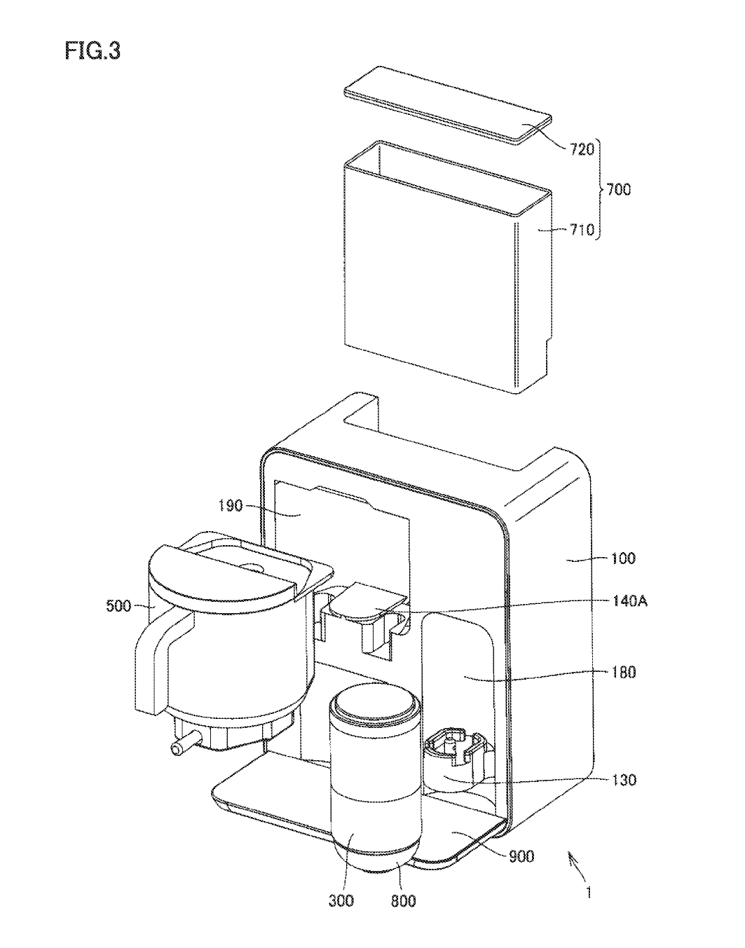

A beverage preparation apparatus 1 in the first embodiment will be described with reference to FIGS. 1 to 3. FIG. 1 is an overall perspective view of beverage preparation apparatus 1. FIG. 2 is a cross-sectional view along the line II-II in FIG. 1. FIG. 3 is an overall perspective view of a schematic component of beverage preparation apparatus 1.

Beverage preparation apparatus 1 uses tea leaves as an object to be grated and obtains tea leaf powders by grating the tea leaves. The beverage preparation apparatus uses the obtained tea leaf powders for preparing tea as a beverage. Beverage preparation apparatus 1 includes an apparatus main body 100, an operation panel 101, a milling unit 300, an agitation unit 500, a water tank 700, a tea leaf powder tray 800, and a placement base 900. Placement base 900 is provided to protrude forward on a front side in a lower portion of apparatus main body 100 and a cup (not shown) and tea leaf powder tray 800 can be placed thereon.

(Milling Unit 300)

Milling unit 300 is removably attached to a milling unit attachment region 180 provided on a front surface side of apparatus main body 100. A milling driving force coupling mechanism 130 is provided in milling unit attachment region 180 so as to protrude forward and milling unit 300 is removably attached to this milling driving force coupling mechanism 130. Milling unit 300 obtains driving force for milling tea leaves representing an object to be grated by being coupled to milling driving force coupling mechanism 130.

Tea leaves introduced from an upper portion of milling unit 300 into milling unit 300 are finely grated in milling unit 300, and dropped and collected as tea leaf powders on tea leaf powder tray 800 placed below milling unit 300.

(Agitation Unit 500)

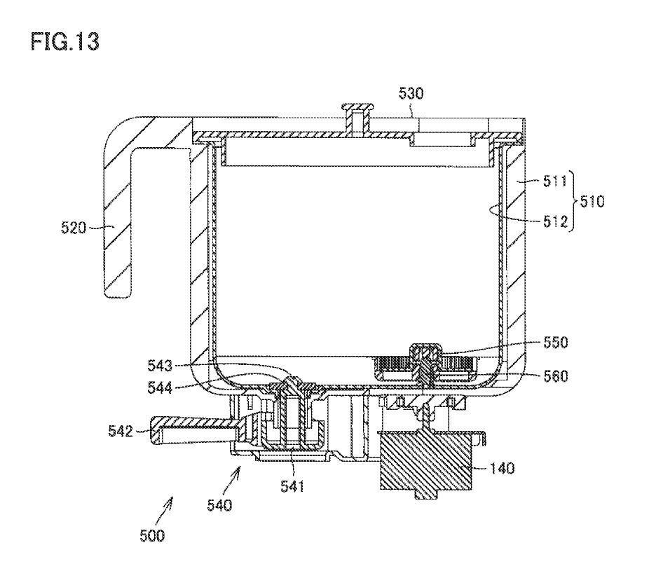

Agitation unit 500 is removably attached to an agitation unit attachment region 190 provided on the front surface side of apparatus main body 100. An agitation motor contactless table 140A is provided in agitation unit attachment region 190 and rotationally drives with magnetic force, an agitation blade 550 (see FIG. 13 which will be described later) provided in agitation unit 500.

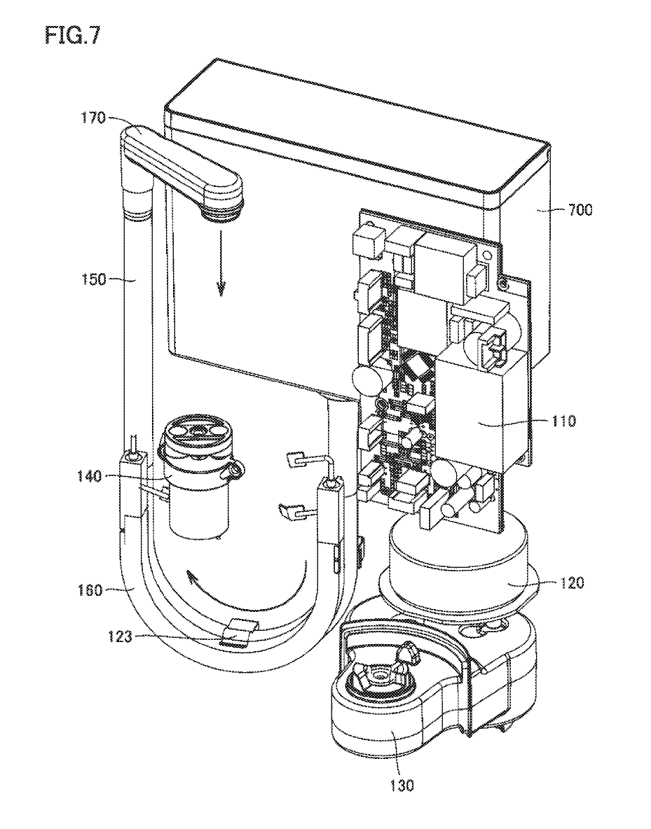

A hot water supply nozzle 170 (see FIG. 7) is provided above agitation unit attachment region 190 of apparatus main body 100. In apparatus main body 100, a temperature of water in water tank 700 is raised to a prescribed temperature and hot water is supplied from hot water supply nozzle 170 into an agitation tank 510. Hot water prepared in apparatus main body 100 and tea leaf powders obtained by milling unit 300 are introduced into agitation tank 510, and hot water and tea leaf powders are agitated by agitation blade 550 in agitation tank 510. Tea is thus prepared in agitation tank 510. Agitation tank 510 represents one example of an accommodation portion for accommodation for mixing of a liquid and powders.

Japanese tea prepared in agitation unit 500 can be poured into a cup (not shown) placed on placement base 900 by operating an operation lever 542 of a discharge port opening and closing mechanism 540 provided below agitation unit 500.

(Flow of Preparation of Japanese Tea (Beverage))

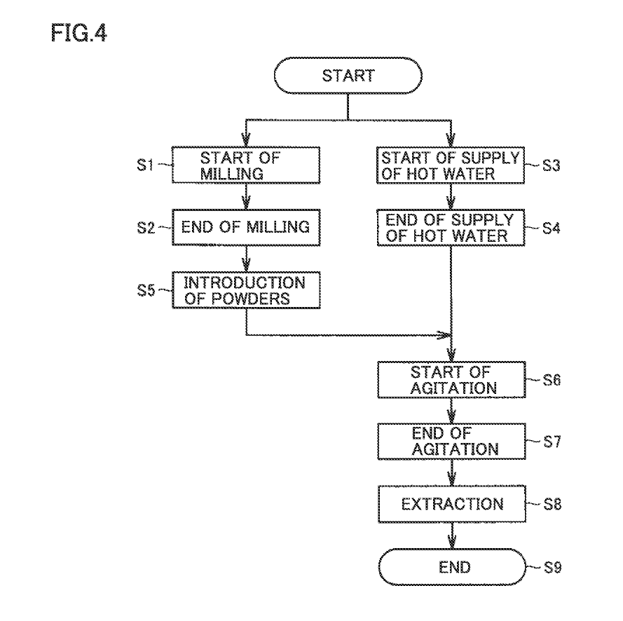

A flow of preparation of Japanese tea (beverage) with the use of beverage preparation apparatus 1 will now be described with reference to FIGS. 4 to 6. FIGS. 4 to 6 show first to third preparation flows showing discharge of Japanese tea using beverage preparation apparatus 1, respectively. A prescribed amount of Japanese tea leaves is introduced into milling unit 300 and a prescribed amount of water is stored in water tank 700.

(First Preparation Flow)

A first preparation flow will be described with reference to FIG. 4. This first preparation flow is a flow in which grating of tea leaves in milling unit 300 and supply of hot water from apparatus main body 100 to agitation unit 500 are simultaneously carried out.

In beverage preparation apparatus 1, milling of tea leaves by milling unit 300 in step S1 is started and supply of hot water from apparatus main body 100 to agitation unit 500 in step S3 is started. Then, milling of tea leaves by milling unit 300 ends in step S2, and supply of hot water from apparatus main body 100 to agitation unit 500 ends in step S4.

In step S5, tea leaf powders obtained in step S2 are introduced into agitation unit 500 by a user.

Then, in step S6, agitation of the tea leaf powders and hot water in agitation unit 500 is started. In step S7, agitation of the tea leaf powders and hot water in agitation unit 500 ends. In step S8, tea is discharged into a cup placed on placement base 900 as the user operates operation lever 542 of discharge port opening and closing mechanism 540 provided below agitation unit 500.

(Second Preparation Flow)

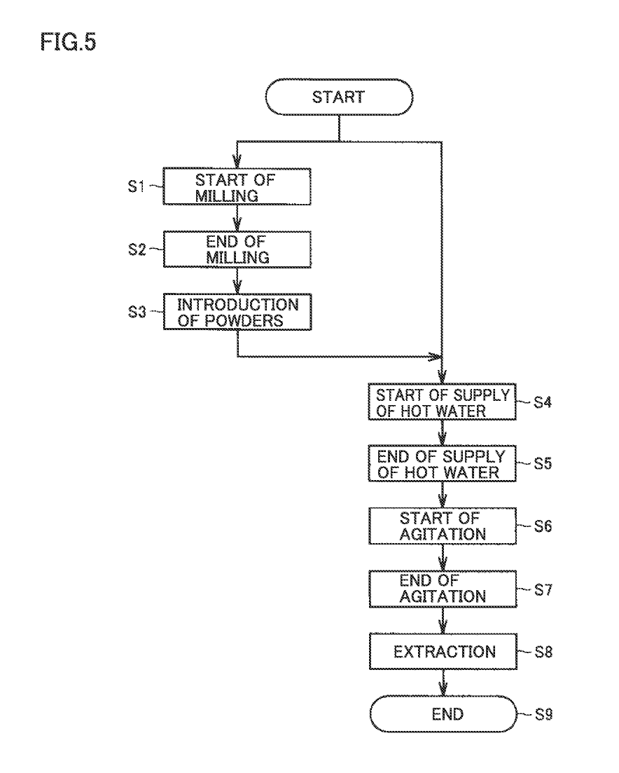

A second preparation flow will be described with reference to FIG. 5. This second preparation flow is a flow in which hot water is supplied from apparatus main body 100 to agitation unit 500 after tea leaves are grated in milling unit 300.

In beverage preparation apparatus 1, in step S1, milling of tea leaves by milling unit 300 is started. In step S2, milling of tea leaves by milling unit 300 ends. In step S3, tea leaf powders obtained in step S2 are introduced into agitation unit 500 by a user.

In step S4, supply of hot water from apparatus main body 100 to agitation unit 500 is started. In step S5, supply of hot water from apparatus main body 100 to agitation unit 500 ends.

Then, in step S6, agitation of the tea leaf powders and hot water in agitation unit 500 is started. In step S7, agitation of the tea leaf powders and hot water in agitation unit 500 ends. In step S8, tea is discharged into a cup placed on placement base 900 as the user operates operation lever 542 of discharge port opening and closing mechanism 540 provided below agitation unit 500.

(Third Preparation Flow)

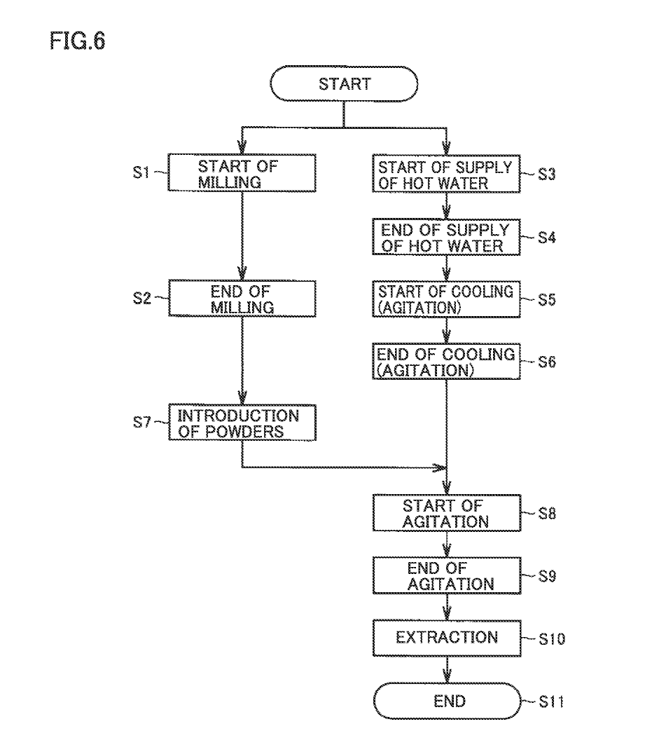

A third preparation flow will be described with reference to FIG. 6. This third preparation flow includes a step of cooling hot water by agitation in agitation unit 500.

In beverage preparation apparatus 1, milling of tea leaves by milling unit 300 in step S1 and supply of hot water from apparatus main body 100 to agitation unit 500 in step S3 are simultaneously started. In step S4, supply of hot water from apparatus main body 100 to agitation unit 500 ends.

Then, in step S2, milling of tea leaves by milling unit 300 ends, and in step S5, cooling by agitation of hot water supply is started in agitation unit 500. In step S6, cooling by agitation of hot water supply in agitation unit 500 ends.

Timing of end of milling and timing of end of agitation by cooling may be controlled to coincide with each other.

In step S7, the tea leaf powders obtained in step S2 are introduced into agitation unit 500 by a user.

Then, in step S8, agitation of the tea leaf powders and hot water in agitation unit 500 is started. In step S9, agitation of the tea leaf powders and hot water in agitation unit 500 ends. In a step 40, tea is discharged into a cup placed on placement base 900 as a user operates operation lever 542 of discharge port opening and closing mechanism 540 provided below agitation unit 500.

(Internal Structure of Apparatus Main Body 100)

An internal structure of beverage preparation apparatus 1 will now be described with reference to FIG. 7. FIG. 7 is a perspective view showing only the internal structure of beverage preparation apparatus 1. In apparatus main body 100 of beverage preparation apparatus 1, a control unit 110 including a printed circuit board on which electronic components are mounted is arranged on a front surface side of water tank 700. Based on input of a start signal by a user, the flow for preparation of tea is executed by control unit 110.

A milling motor unit 120 for providing driving force to milling unit 300 is arranged at a position below control unit 110 (printed circuit board). Milling driving force coupling mechanism 130 provided to protrude forward for transmitting driving force of milling motor unit 120 to milling unit 300 is provided at a position below milling motor unit 120.

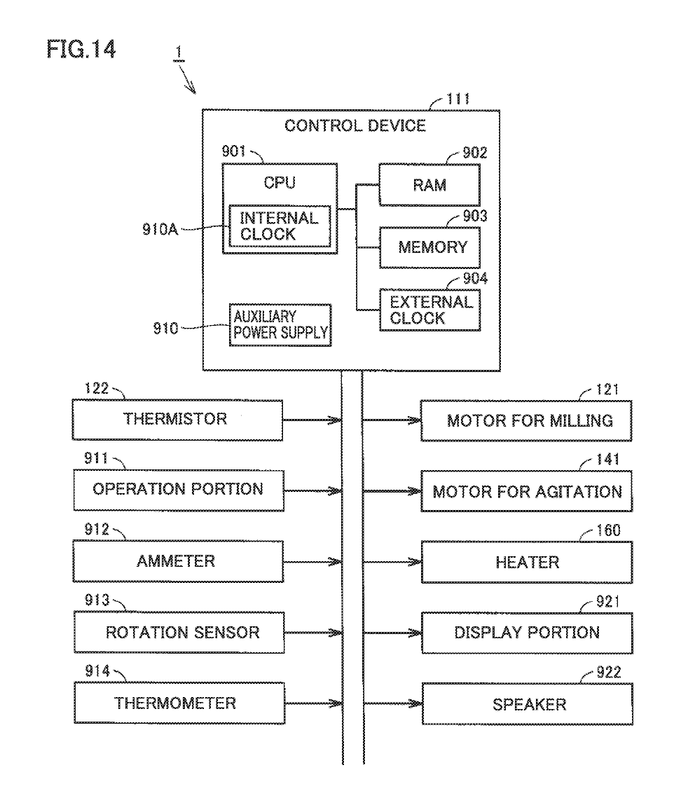

To a bottom surface of water tank 700, one end of a hot water supply pipe 150 extending once downward from the bottom surface and then extending upward in a U shape is coupled. Hot water supply nozzle 170 for pouring hot water into agitation tank 510 of agitation unit 500 is coupled to an upper end portion of hot water supply pipe 150. A U-shaped heater 160 for heating water which passes through hot water supply pipe 150 is attached to an intermediate region of hot water supply pipe 150. A thermistor 123 for measuring a temperature of water which passes through hot water supply pipe 150 is attached to hot water supply pipe 150. Beverage preparation apparatus 1 includes a pump (a pump 261 in FIG. 14) which delivers water (hot water) in hot water supply pipe 150 to hot water supply nozzle 170.

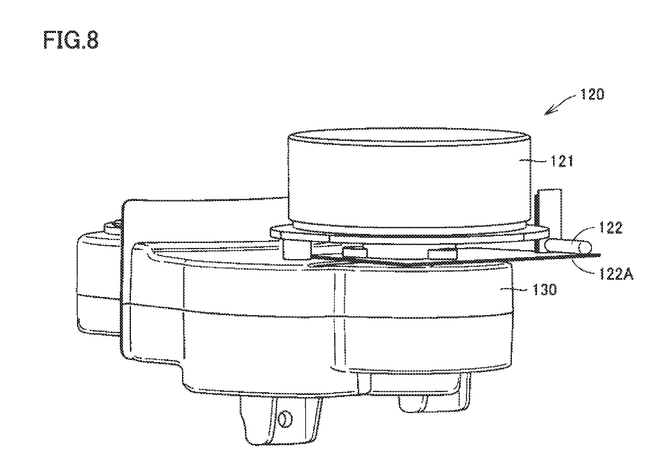

FIG. 8 is an enlarged view of a structure around milling motor unit 120. Referring to FIG. 8, milling motor unit 120 includes a motor for milling 121, a metal plate 122A for attaching motor for milling 121 to milling driving force coupling mechanism 130, and a thermistor 122 attached to metal plate 122A. Motor for milling 121 is attached to metal plate 122A. Heat conducts from motor for milling 121 to thermistor 122 through metal plate 122A. Thus, thermistor 122 can measure a temperature on an outer surface of motor for milling 121.

(Structure of Milling Unit 300)

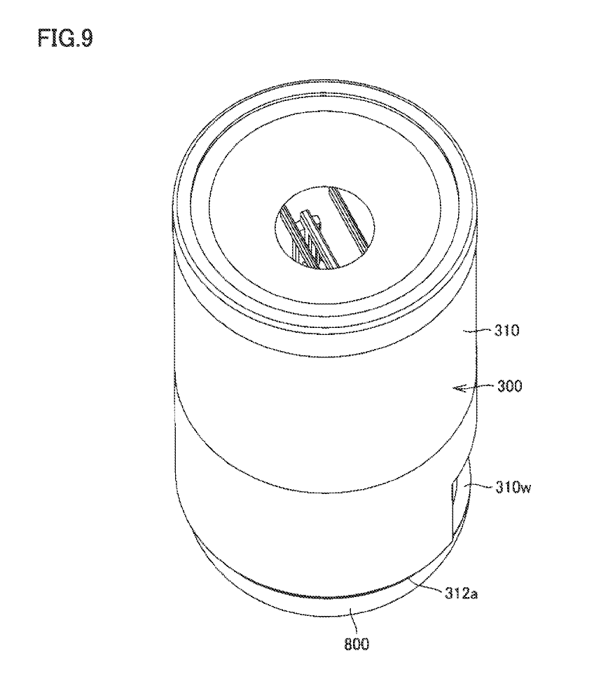

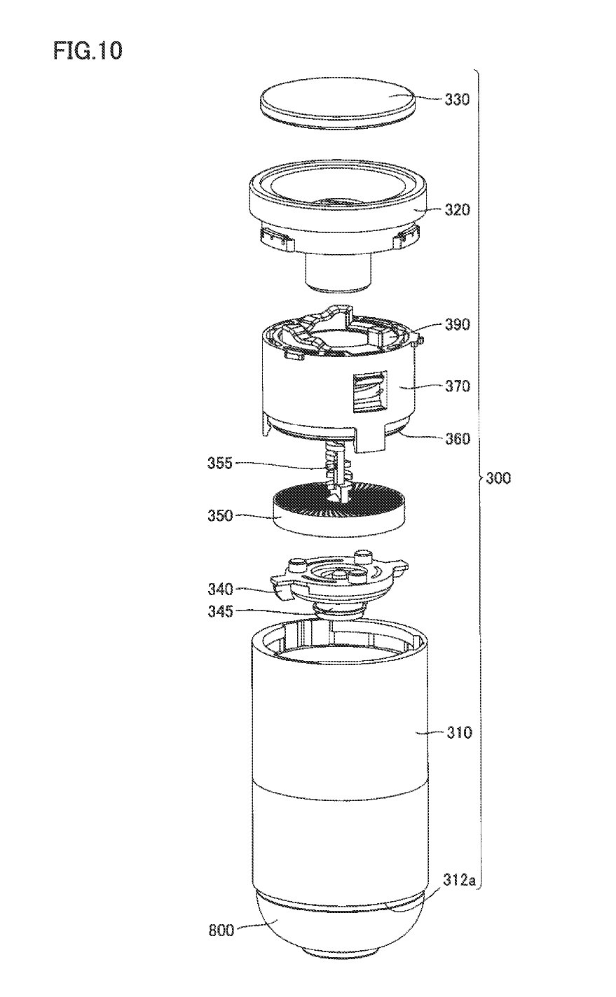

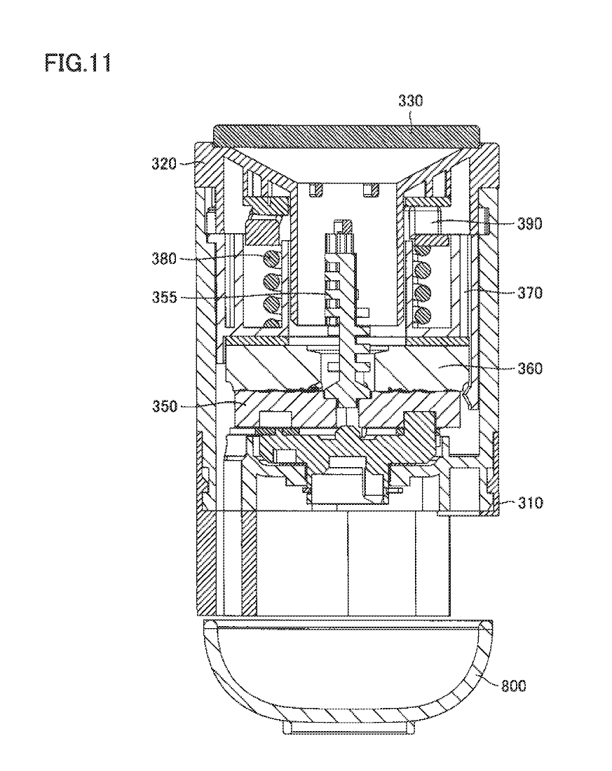

A structure of milling unit 300 will now be described with reference to FIGS. 9 to 11. FIG. 9 is a perspective view of milling unit 300. FIG. 10 is an exploded perspective view of milling unit 300. FIG. 11 is a vertical cross-sectional view of milling unit 300.

Milling unit 300 has a milling case 310 having a cylindrical shape as a whole, and a window 310w for coupling in which milling driving force coupling mechanism 130 is inserted is provided in a side surface below. An outlet port 312a is formed at a lowermost end portion of milling case 310 from which powders of tea leaves grated by milling unit 300 are taken out (drop).

A powder scraper 340, a lower mill 350, and an upper mill 360 are sequentially provided from below, in the inside of milling case 310. A milling shaft 345 extending downward is provided on a lower surface of powder scraper 340 and coupled to milling driving force coupling mechanism 130.

A core 355 extending upward along a core of a rotation shaft is provided in the central portion of lower mill 350. Upper mill 360 is held by an upper mill holding member 370, and a spring 380 and a spring holding member 390 pressing upper mill 360 downward are accommodated in upper mill holding member 370.

Core 355 provided in lower mill 350 extends upward to pass through upper mill 360.

Upper mill 360 and lower mill 350 in the first embodiment have a radius r approximately from 15 mm to 30 mm, and upper mill 360 and lower mill 350 have a thickness t1 around 8 mm. A relative rotation speed W of upper mill 360 and lower mill 350 is approximately 60 rpm≦W≦150 rpm. Thus, processing capability can be obtained based on a rotation speed in compensation for decrease in area of contact between the mills and reduction in necessary torque, and processing capability per necessary torque can thereby be enhanced rather than by increasing an area.

(Structure of Agitation Unit 500)

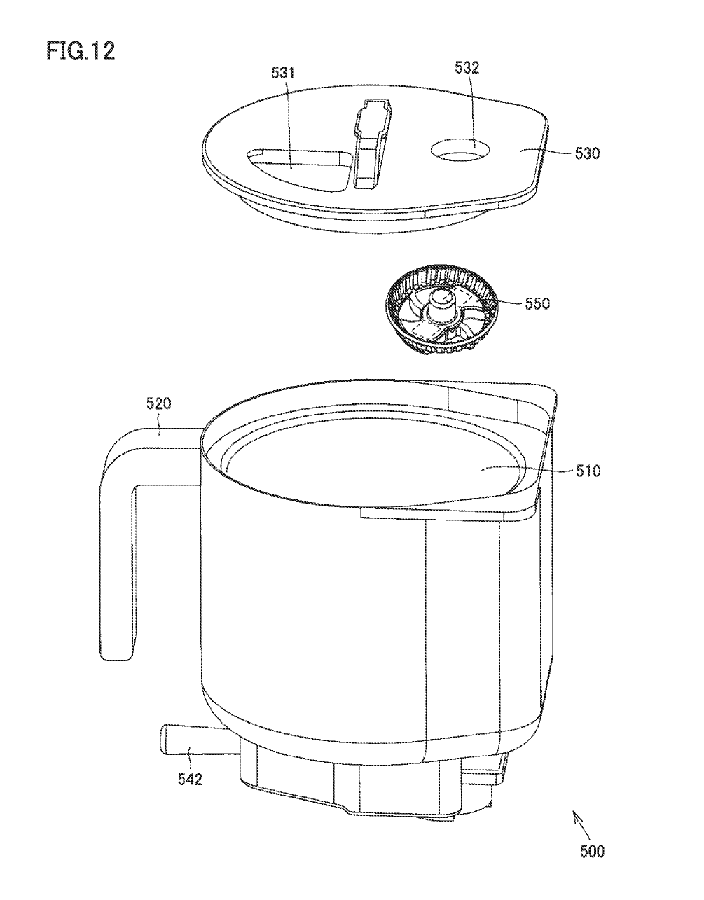

A structure of agitation unit 500 will now be described with reference to FIGS. 12 and 13. FIG. 12 is a perspective view of agitation unit 500. FIG. 13 is a vertical cross-sectional view of agitation unit 500.

Agitation unit 500 includes agitation tank 510. Agitation tank 510 includes an exterior holder 511 made of a resin and a thermally insulated tank 512 held by this exterior holder 511. An integrally resin molded grip 520 is provided in exterior holder 511. Over an upper opening of agitation tank 510, an agitation cover 530 opening and closing the opening is provided. Agitation cover 530 is provided with a powder inlet 531 through which tea leaf powders grated by milling unit 300 are introduced and a hot water supply inlet 532 formed in apparatus main body 100, through which hot water is poured from hot water supply nozzle 170.

Agitation blade 550 is placed on a bottom portion of agitation tank 510. Agitation unit 500 further includes an agitation motor unit 140 including a motor for agitation 141 (see FIG. 14) for rotating agitation blade 550. A rotation shaft 560 extending upward is provided on the bottom portion of agitation tank 510, and a bearing portion 551 for agitation blade 550 is inserted in this rotation shaft 560.

A magnet is embedded in agitation blade 550. In agitation motor contactless table 140A, the magnet embedded in agitation blade 550 and a magnet provided on a side of agitation motor unit 140 are magnetically coupled in a contactless state, so that rotational driving force of agitation motor unit 140 is transmitted to agitation blade 550.

A discharge port 541 for discharging agitated tea is provided in the bottom portion of agitation tank 510. Discharge port opening and closing mechanism 540 is provided at discharge port 541. Discharge port opening and closing mechanism 540 includes an opening and closing nozzle 543 inserted into discharge port 541 so as to be able to open and close discharge port 541 and operation lever 542 controlling a position of opening and closing nozzle 543. Opening and closing nozzle 543 is biased to close discharge port 541 by a biasing member (not shown) such as a spring in a normal state. When a user moves operation lever 542 against biasing force, opening and closing nozzle 543 moves to open discharge port 541 and thus tea in agitation tank 510 is poured into a cup (not shown) placed on placement base 900.

(Hardware Configuration)

FIG. 14 is a diagram showing one example of a hardware configuration of beverage preparation apparatus 1 in the first embodiment. As shown in FIG. 14, beverage preparation apparatus 1 includes a control device 111 for controlling an operation of beverage preparation apparatus 1. In beverage preparation apparatus 1 in the first embodiment, control device 111 is located in control unit 110 (see FIG. 7). Arrangement of control device 111 is not limited as such.

Control device 111 includes a CPU 901 for control by execution of a program, a random access memory (RAM) 902 functioning as a work area for CPU 901, a memory 903 for non-transitory storage of data such as a program, and an external clock (a clock oscillation circuit) 904. Memory 903 is implemented, for example, by an electrically erasable programmable read-only memory (EEPROM).

Control device 111 is connected to thermistor 122, motor for milling 121, motor for agitation 141, heater 160, and pump 261 through a bus. Beverage preparation apparatus 1 further includes an operation portion 911, an ammeter 912, a rotation sensor 913, a thermometer 914, a display portion 921, external clock 904, an auxiliary power supply 910, and a speaker 922.

Operation portion 911 is operated for inputting information to CPU 901 and implemented, for example, by one or more buttons. Ammeter 912 measures a current value in motor for milling 121 and inputs the current value to CPU 901. Rotation sensor 913 measures a rotation signal of motor for milling 121 and inputs the rotation signal to CPU 901. Thermometer 914 measures a temperature of water stored in water tank 700 (or water in hot water supply pipe 150) and inputs the temperature to CPU 901. Thermometer 914 is provided, for example, on an inner surface of a cover of beverage preparation apparatus 1 so as to measure a temperature at a portion exhibiting a temperature which can be close to a temperature of water in water tank 700. Display portion 921 is provided to output information to the outside of beverage preparation apparatus 1. Display portion 921 is implemented, for example, by a plurality of indicators. CPU 901 gives a notification of end of grating of an object to be grated, for example, by turning on a prescribed indicator in display portion 921. Speaker 922 outputs voice and sound. CPU 901 notifies end of grating of an object to be grated, for example, by having speaker 922 output voice and sound.

CPU 901 has each portion in beverage preparation apparatus 1 operate by being supplied with electric power from a not-shown external power supply. CPU 901 performs a time counting operation by making use of external clock 904 when it is supplied with electric power from the external power supply. CPU 901 includes an internal clock 910A. When supply of electric power from the external power supply cannot be received, for example, due to removal of a plug from an outlet, CPU 901 performs the time counting operation by being supplied with electric power from auxiliary power supply 910 and making use of internal clock 910A. Auxiliary power supply 910 is implemented, for example, by a capacitor or a storage battery. CPU 901 can have auxiliary power supply 910 store electric power which is supplied from the external power supply. Internal clock 910A is lower in power consumption than external clock 904. Therefore, auxiliary power supply 910 is implemented, for example, by a double layer capacitor at approximately 0.22 Fa (farad).

(Control Flow)

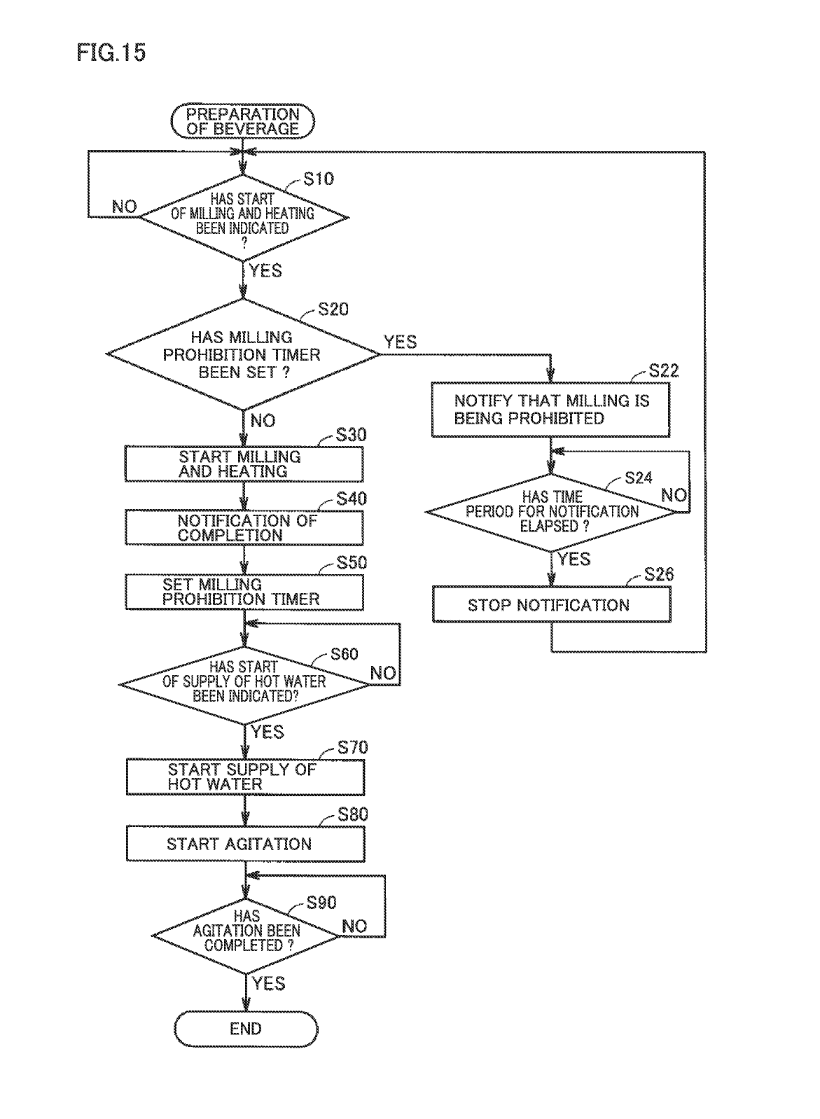

A specific control flow for preparation of a beverage including grating of tea leaves and supply of hot water to agitation unit 500 in beverage preparation apparatus 1 will now be described. FIG. 15 is a flowchart of one example of processing performed in beverage preparation apparatus 1 for preparation of a beverage.

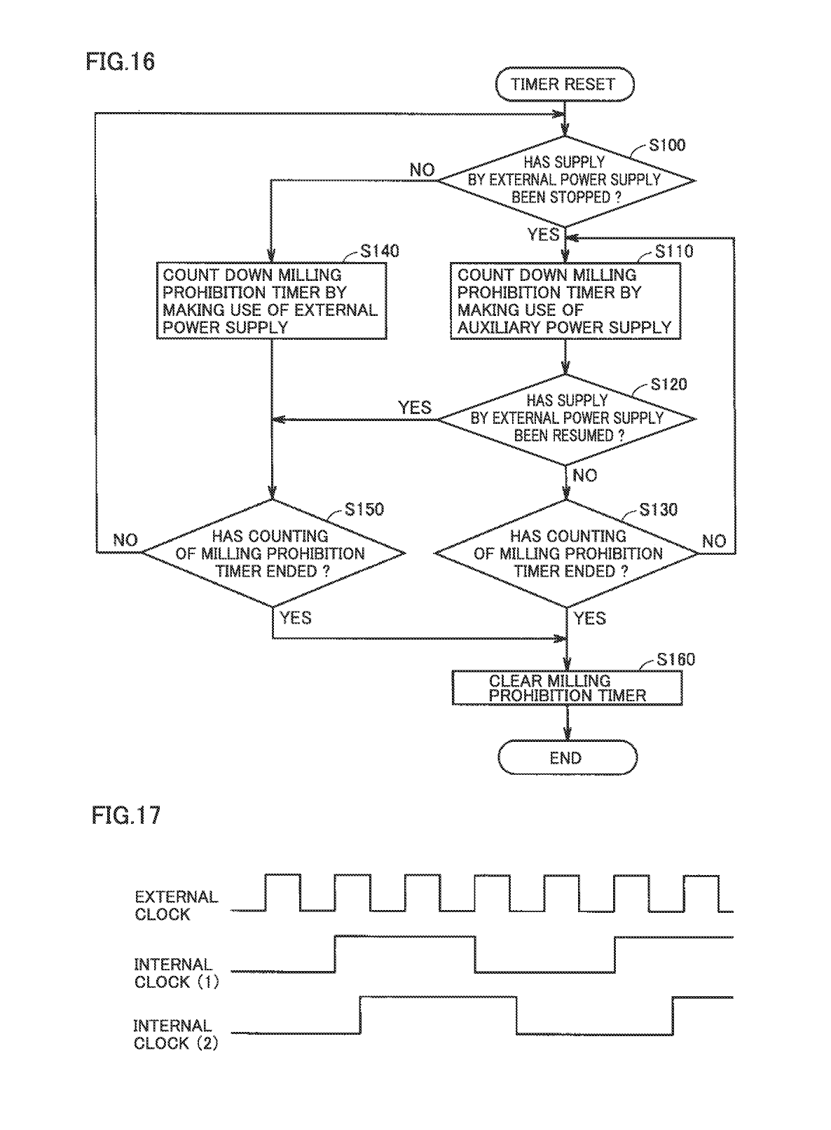

In the processing shown in FIG. 15, a “milling prohibition timer” is made use of. The milling prohibition timer counts a “prescribed period of time” in order not to perform a next milling operation for a prescribed period of time (for example, “30 minutes”) after milling motor unit 120 performed the milling operation. The milling prohibition timer is set in step S50, counted down in step S110 or step S140 in a process in FIG. 16 which will be described later, and cleared in step S160. The prescribed period of time should only be a time period until lower mill 350 and upper mill 360 heated by friction during the milling operation are cooled to a safe temperature by atmosphere or the like and the “30 minutes” represents merely one example.

Referring to FIG. 15, CPU 901 determines in step S10 whether or not start of grating (milling) of tea leaves and heating of water has been indicated. When CPU 901 determines that such an instruction has been given, control proceeds to step S20.

CPU 901 determines in step S20 whether or not the milling prohibition timer has been set. When CPU 901 determines that the milling prohibition timer has been set, control proceeds to step S22. When the CPU determines that the milling prohibition timer has not been set, control proceeds to step S30.

In step S22, CPU 901 notifies that milling is being prohibited, and control proceeds to step S24.

CPU 901 determines in step S24 whether or not a predetermined period of time (a time period for notification) has elapsed since start of notification in step S22. When the CPU determines that the predetermined period of time has elapsed, control proceeds to step S26.

In step S26, CPU 901 stops the notification started in step S22, and control returns to step S10.

According to control in step S22 to step S26, even though CPU 901 accepts an instruction to start grating (milling) of tea leaves and heating of water in step S10, the CPU waits for input of a next instruction without allowing milling motor unit 120 to perform milling. The notification in step S30 may be provided as output of voice and sound from speaker 922 or output of visual information on display portion 921.

When the notification is provided as output of voice and sound and as output of a predetermined message, the notification can end without waiting for lapse of the time period for notification as in control in steps S24 and S26.

In step S30, CPU 901 has milling motor unit 120 start the milling operation and has heater 160 start the heating operation. When both of the operations are completed, control proceeds to step S40.

In step S40, CPU 901 notifies that the milling operation and the heating operation have been completed. The notification is given, for example, by representation on display portion 921 and/or output of voice and sound from speaker 922. Control then proceeds to step S50. When the milling operation out of the milling operation and the heating operation started in step S30 is completed before the heating operation, CPU 901 may give a notification in step S40 that the milling operation has been completed without waiting for completion of the heating operation. When the heating operation is completed before the milling operation, CPU 901 may give a notification in step S40 that the heating operation has been completed without waiting for completion of the milling operation.

In step S50, CPU 901 starts the milling prohibition timer. Control then proceeds to step S60.

CPU 901 determines in step S60 whether or not start of supply of hot water to agitation tank 510 has been indicated. When CPU 901 determines that such an instruction has been given, control proceeds to step S70. A user introduces grated tea leaves into agitation tank 510 before the user gives an instruction to start supply of hot water to agitation tank 510.

In step S70, CPU 901 has supply of hot water to agitation tank 510 started by driving pump 261. Control then proceeds to step S80. Supply of hot water is stopped when a predetermined condition (for example, supply of hot water in an amount corresponding to strength of a beverage and/or the number of servings which have/has been set is completed) is satisfied.

In step S80, CPU 901 has agitation unit 500 start agitation of a solution in agitation tank 510. Control then proceeds to step S90.

CPU 901 determines in step S90 whether or not a condition for completion of agitation started in step S80 has been satisfied. For example, a condition for completion of agitation is satisfied when a predetermined period of time has elapsed since start of agitation. CPU 901 specifies elapsed time since start of agitation by referring to the time counted by external clock 904. When CPU 901 determines that the condition for completion of agitation has been satisfied, it has agitation unit 500 stop agitation and the process in FIG. 15 ends.

In the process described with reference to FIG. 15 above, when the milling operation is completed and the “milling prohibition timer” is set in step S50, the milling operation by milling motor unit 120 is not performed until the timer is cleared in step S160 which will be described later even though an instruction for milling is input.

(Countdown and Reset of Milling Prohibition Timer)

Processing for countdown and reset of the milling prohibition timer will now be described. FIG. 16 is a flowchart of processing performed in beverage preparation apparatus 1 for countdown and reset of the milling prohibition timer. The processing in FIG. 16 is started on condition that the “milling prohibition timer” is set in step S50 in FIG. 15, and performed in parallel to the processing in FIG. 15.

Referring to FIG. 16, CPU 901 determines in step S100 whether or not supply of electric power from the external power supply to beverage preparation apparatus 1 has been stopped. When CPU 901 determines that supply has been stopped, control proceeds to step S110. When the CPU determines that supply has not been stopped, control proceeds to step S140.

In step S110, CPU 901 counts down the milling prohibition timer with electric power supplied from auxiliary power supply 910. Control then proceeds to step S120.

CPU 901 determines in step S120 whether or not supply of electric power from the external power supply to beverage preparation apparatus 1 has been resumed. When CPU 901 determines that supply has been resumed, control proceeds to step S150. When CPU 901 determines that supply has not been resumed, control proceeds to step S130.

CPU 901 determines in step S130 whether or not counting of the milling prohibition timer has ended. When the CPU determines that counting has ended, control proceeds to step S160. When the CPU determines that the counting has not yet ended, control returns to step S110.

In step S140, CPU 901 receives supply of electric power from the external power supply and counts down the milling prohibition timer. Control then proceeds to step S150.

CPU 901 determines in step S150 whether or not counting of the milling prohibition timer has ended. Then, when the CPU determines that counting has ended, control proceeds to step S160. When the CPU determines that counting has not yet ended, control returns to step S100.

In step S160, CPU 901 clears the milling prohibition timer and the process ends.

As described above with reference to FIG. 16, when counting of the milling prohibition timer ends in beverage preparation apparatus 1, the milling prohibition timer is cleared. Thus, when start of milling is indicated in step S10 (see FIG. 15), the milling operation by milling motor unit 120 is performed in step S30.

Even when supply of electric power from the external power supply is stopped, for example, due to removal of a plug of beverage preparation apparatus 1 from an outlet, CPU 901 continues to count down the milling prohibition timer by being supplied with electric power from auxiliary power supply 910. Thus, interruption of countdown of the milling prohibition timer due to stop of supply of electric power from the external power supply and the timer being cleared before the end of counting of the milling prohibition timer due to stop of supply of electric power from the external power supply (erasure of set data that the timer has been set) can be avoided. Therefore, the milling operation can reliably be prohibited for a time period equal to or longer than a period of time counted by the milling prohibition timer.

### Second Embodiment

A hardware configuration of the beverage preparation apparatus in a second embodiment can be the same as in beverage preparation apparatus 1 in the first embodiment. Beverage preparation apparatus 1 in the second embodiment has information for correcting a clock from internal clock 910A with a clock from external clock 904 (information for correction). Then, when CPU 901 counts down the milling prohibition timer by receiving supply of electric power from auxiliary power supply 910 in the processing as described with reference to FIG. 16, the CPU counts down the timer while it corrects the clock from internal clock 910A with the information for correction.

FIG. 17 is a diagram schematically showing clocks from three types of clock oscillation circuits. An “external clock” in FIG. 17 represents one example of a clock oscillated by external clock 904. An “internal clock (1)” and an “internal clock (2)” represent two examples of clocks oscillated by a clock oscillation circuit which can be made use of as internal clock 910A. In beverage preparation apparatus 1 in the second embodiment, a clock oscillation circuit relatively high in accuracy is made use of as external clock 904, whereas a clock oscillation circuit low in accuracy is made use of as internal clock 910A. Therefore, variation among individual clocks oscillated by internal clock 910A is great. Difference between the “internal clock (1)” and the “internal clock (2)” in FIG. 17 corresponds to variation between clocks oscillated by the clock oscillation circuit made use of as internal clock 910A.

The clocks oscillated by the clock oscillation circuit made use of as internal clock 910A are varied as shown in FIG. 17. Therefore, a time period from setting of the milling prohibition timer to end of countdown may be different between a case that the milling prohibition timer is counted down with auxiliary power supply 910 as described with reference to FIG. 16 and with internal clock 910A and a case that the timer is counted down with the external power supply and with external clock 904.

In the second embodiment, CPU 901 generates information for correction by making use of a ratio of an oscillation period between internal clock 910A in beverage preparation apparatus 1 and external clock 904. When CPU 901 counts down the milling prohibition timer with auxiliary power supply 910 and with internal clock 910A, it counts down the timer while it corrects the clock from internal clock 910A with the information for correction. Thus, variation in time period from setting of the milling prohibition timer to end of countdown can be lessened.

### Third Embodiment

A hardware configuration of the beverage preparation apparatus in a third embodiment can be the same as in beverage preparation apparatus 1 in the first embodiment. In beverage preparation apparatus 1 in the third embodiment, a length of a time period counted by the milling prohibition timer, that is, a time period required from setting of the timer to countdown, is changed in accordance with the number of servings of a beverage set for milling. For example, when an instruction to prepare one to three servings of a beverage can be given in one instruction for preparation of the beverage in beverage preparation apparatus 1, CPU 901 selects a timer to be set such that a time period to be counted by the milling prohibition timer is longer when preparation of two servings of the beverage is indicated than when preparation of one serving of the beverage is indicated.

As the number of servings indicated in one preparation of a beverage is greater, an amount of tea leaves to be used is greater, and thus a time period for the milling operation performed by milling motor unit 120 is expected to be longer. Temperature increase in lower mill 350 and upper mill 360 is also expected to be greater with a longer period of time for the milling operation.

In the third embodiment, a time period counted by the milling prohibition timer is adjusted as described above, so that a period during which the milling operation is not performed can be longer as a temperature is expected to be higher.

A time period counted by the milling prohibition timer may be set in accordance with a time period for the milling operation performed in one preparation of a beverage, instead of the number of servings indicated in one preparation of a beverage. For example, a time period counted by the milling prohibition timer is set to twice as long as the time period for the milling operation. Specifically, when the milling operation is performed for 2 minutes, the time period counted by the milling prohibition timer is thereafter set to 4 minutes so that the milling operation is prohibited for 4 minutes.

### Fourth Embodiment

A hardware configuration of the beverage preparation apparatus in a fourth embodiment can be the same as in beverage preparation apparatus 1 in the first embodiment. Beverage preparation apparatus 1 in the fourth embodiment does not set the milling prohibition timer in some cases even though the milling operation is performed. More specifically, CPU 901 in beverage preparation apparatus 1 in the fourth embodiment determines whether or not to set the milling prohibition timer based not only on end of one milling operation but also on history of milling operations which have been performed.

For example, CPU 901 sets the milling prohibition timer in step S50 (see FIG. 15) on condition that a specific condition has been satisfied. The specific condition includes, for example, such a condition that the milling operations have successively been performed at an interval not longer than a certain period (for example, 15 minutes) and an accumulated value of periods of such successive milling operations reaches a specific time period (for example, 30 minutes).

Whether or not to set the milling prohibition timer is determined based on history of the milling operations (a length of a substantial duration of the milling operation) as in the fourth embodiment, so that the milling operation can be prohibited only when lower mill 350 and upper mill 360 should be cooled. Thus, beverage preparation apparatus 1 can avoid as much as possible such a situation that the milling operation cannot be performed because of cooling of lower mill 350 and upper mill 360 when a user desires to perform the milling operation.

### Fifth Embodiment

A hardware configuration of the beverage preparation apparatus in a fifth embodiment can be the same as in beverage preparation apparatus 1 in the first embodiment. Beverage preparation apparatus 1 in the fifth embodiment performs the milling operation with the number of relative rotations of lower mill 350 and upper mill 360 being reduced, rather than the milling operation not performed during a period in which the milling prohibition timer has been set. Thus, beverage preparation apparatus 1 can avoid as much as possible such a situation that the milling operation cannot be performed when a user desires the milling operation.

### Sixth Embodiment

A hardware configuration of the beverage preparation apparatus in a sixth embodiment can be the same as in beverage preparation apparatus 1 in the first embodiment. In beverage preparation apparatus 1 in the sixth embodiment, a temperature in the vicinity of lower mill 350 and/or upper mill 360 is measured instead of making use of the milling prohibition timer.

Specifically, when a measured temperature exceeds a specific temperature, beverage preparation apparatus 1 in the sixth embodiment prohibits the milling operation until the measured temperature is equal to or lower than the specific temperature. “Prohibition” may be not allowing the milling operation or reduction in number of relative rotations between lower mill 350 and upper mill 360 in the milling operation.

[Specific Example of Control Device]

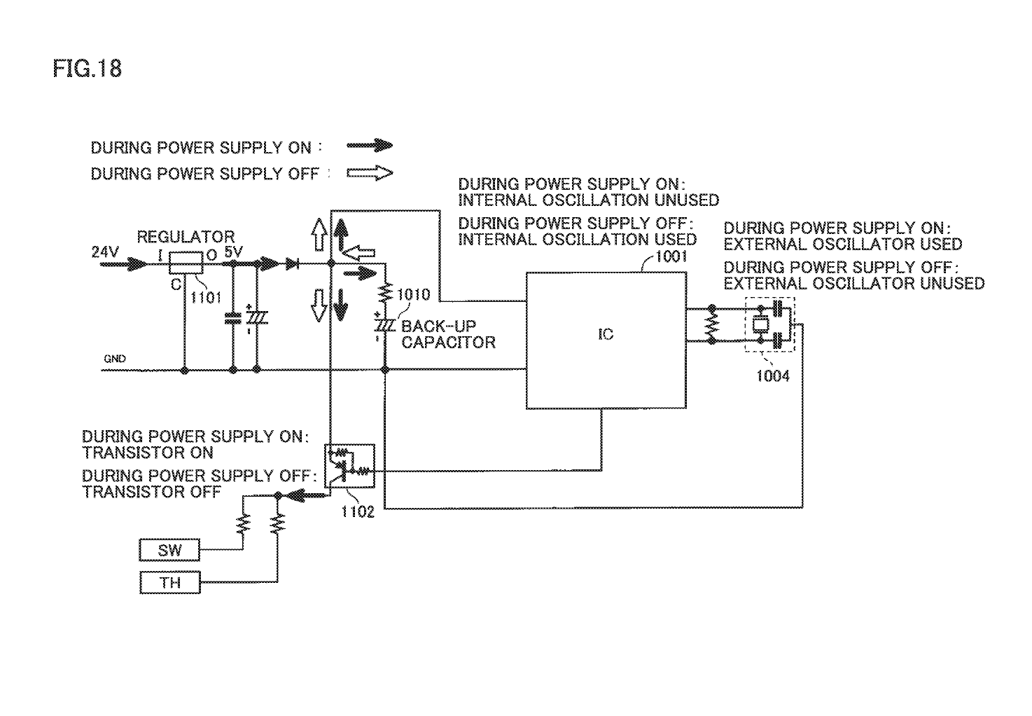

FIG. 18 is a diagram showing a specific example of a configuration of CPU 901 and external clock 904 in control device 111 (see FIG. 14) as well as peripheral devices thereof. In the specific example shown in FIG. 18, an integrated circuit (IC) 1001 is shown as a specific example of CPU 901. A clock oscillation circuit 1004 is shown as a specific example of external clock 904. A capacitor 1010 is shown as a specific example of auxiliary power supply 910.

FIG. 18 shows with a bold arrow, a flow of a current during a period in which electric power is supplied from the external power supply to beverage preparation apparatus 1. A flow of a current during a period in which supply of electric power from the external power supply to beverage preparation apparatus 1 has been stopped is shown with a hollow arrow.

Referring to FIG. 18, during a period in which beverage preparation apparatus 1 is supplied with electric power from the external power supply, a voltage of 24 V from the external power supply is down-converted to 5 V by a regulator 1101 and then supplied to IC 1001. IC 1001 has electric power supplied to clock oscillation circuit 1004. As IC 1001 turns on a transistor 1102 (renders the transistor conducting), electric power from the external power supply is supplied to various components such as a switch (SW) and a thermistor (TH) through transistor 1102. Capacitor 1010 is charged with electric power from the external power supply.

During a period in which supply of electric power from the external power supply to beverage preparation apparatus 1 has been stopped, IC 1001 does not allow electric power supply to clock oscillation circuit 1004, but drives the clock oscillation circuit within IC 1001 with electric power stored in capacitor 1010 so as to have the milling prohibition timer perform the counting operation. IC 1001 does not allow supply of electric power to various components such as the switch (SW) and the thermistor (TH) by turning off transistor 1102 (rendering the transistor non-conducting).

In the embodiments disclosed herein, a time period “15 minutes” is exemplified as the upper limit of the number of rotations of the mill. Thus, an operation for counting at least “30 minutes” is necessary as the upper limit for the counting operation by the milling prohibition timer. The auxiliary power supply (capacitor 1010) has at least a capacity necessary for driving only IC 1001 (CPU 901) for 30 minutes with transistor 1102 being turned off. In order to drive IC 1001 (CPU 901) for 30 minutes, a capacity to some extent is required. Therefore, in the embodiments above, an electric double layer capacitor (called a supercapacitor) relatively high in capacity may be adopted by way of example of capacitor 1010.

It should be understood that the embodiments and modifications thereof disclosed herein are illustrative and non-restrictive in every respect. The scope of the present disclosure is defined by the terms of the claims, rather than the description above, and is intended to include any modifications within the scope and meaning equivalent to the terms of the claims.

### REFERENCE SIGNS LIST

1 beverage preparation apparatus;
100 apparatus main body;
101 operation panel;
110 control unit;
111 control device;
120 milling motor unit;
121 motor for milling;
122, 123 thermistor;
122A metal plate;
130 milling driving force coupling mechanism;
140 agitation motor unit;
140A contactless table;
141 motor for agitation;
150 hot water supply pipe;
160 heater;
170 hot water supply nozzle;
180 unit attachment region;
190 agitation unit attachment region;
261 pump;
300 milling unit;
310 milling case;
310w window for coupling;
312a outlet port;
340 powder scraper;
345 milling shaft;
350 lower mill;
355 core;
360 upper mill;
370 upper mill holding member;
380 spring;
390 spring holding member;
500 agitation unit;
510 agitation tank;
511 exterior holder;
512 thermally insulated tank;
531 powder inlet;
532 hot water supply inlet;
540 discharge port opening and closing mechanism;
541 discharge port;
542 operation lever;
543 opening and closing nozzle;
550 agitation blade;
551 bearing portion;
560 rotation shaft;
700 water tank;
800 tea leaf powder tray;
900 placement base;
903 memory;
904 external clock;
910 auxiliary power supply;
910A internal clock;
911 operation portion;
912 ammeter;
913 rotation sensor;
914 thermometer;
921 display portion;
922 speaker;
1001 IC;
1004 clock oscillation circuit;
1010 capacitor;
1101 regulator; and
1102 transistor.

1. An electric milling machine for grating food, the electric milling machine comprising:
a grating mechanism for producing powders of food by grating the food by relatively moving two or more members which abut to each other; and
a control unit configured to control an operation of the grating mechanism,
the control unit being configured to perform processing for making transition to a grating prohibition mode for prohibiting an operation for grating the food by the grating mechanism after grating of the food by the grating mechanism and prohibiting the grating operation by the grating mechanism until a prescribed condition is satisfied.

2. The electric milling machine according to claim 1, wherein
the prescribed condition includes lapse of a prescribed period of time.

3. The electric milling machine according to claim 1, wherein
the control unit is configured to be supplied with electric power from an external power supply,
the electric milling machine further comprises an internal power supply for supplying electric power to the control unit when supply of electric power from the external power supply is cut off, and
the control unit is configured to execute the grating prohibition mode with electric power supplied from the internal power supply when supply of electric power from the external power supply is cut off.

4. The electric milling machine according to claim 1, wherein
the control unit is configured to set the prescribed condition based on a manner of grating of the food by the grating mechanism.

5. The electric milling machine according to claim 1, the electric milling machine further comprising:
a first oscillation circuit for oscillating a clock with electric power supplied from the external power supply;
a second oscillation circuit for oscillating a clock with electric power supplied from the internal power supply; and
storage means for storing information for correcting the clock from the second oscillation circuit based on the clock from the first oscillation circuit, wherein
the control unit is configured to correct the clock emitted from the second oscillation circuit with the information and to use the corrected clock when the control unit performs the processing with electric power supplied from the internal power supply.

6. The electric milling machine according to claim 2, wherein
the control unit is configured to be supplied with electric power from an external power supply,
the electric milling machine further comprises an internal power supply for supplying electric power to the control unit when supply of electric power from the external power supply is cut off, and
the control unit is configured to execute the grating prohibition mode with electric power supplied from the internal power supply when supply of electric power from the external power supply is cut off.

7. The electric milling machine according to claim 2, wherein
the control unit is configured to set the prescribed condition based on a manner of grating of the food by the grating mechanism.

8. The electric milling machine according to claim 3, wherein
the control unit is configured to set the prescribed condition based on a manner of grating of the food by the grating mechanism.

9. The electric milling machine according to claim 2, the electric milling machine further comprising:
a first oscillation circuit for oscillating a clock with electric power supplied from the external power supply;
a second oscillation circuit for oscillating a clock with electric power supplied from the internal power supply; and
storage means for storing information for correcting the clock from the second oscillation circuit based on the clock from the first oscillation circuit, wherein
the control unit is configured to correct the clock emitted from the second oscillation circuit with the information and to use the corrected clock when the control unit performs the processing with electric power supplied from the internal power supply.

10. The electric milling machine according to claim 3, the electric milling machine further comprising:
a first oscillation circuit for oscillating a clock with electric power supplied from the external power supply;
a second oscillation circuit for oscillating a clock with electric power supplied from the internal power supply; and
storage means for storing information for correcting the clock from the second oscillation circuit based on the clock from the first oscillation circuit, wherein
the control unit is configured to correct the clock emitted from the second oscillation circuit with the information and to use the corrected clock when the control unit performs the processing with electric power supplied from the internal power supply.

11. The electric milling machine according to claim 4, the electric milling machine further comprising:
a first oscillation circuit for oscillating a clock with electric power supplied from the external power supply;
a second oscillation circuit for oscillating a clock with electric power supplied from the internal power supply; and
storage means for storing information for correcting the clock from the second oscillation circuit based on the clock from the first oscillation circuit, wherein
the control unit is configured to correct the clock emitted from the second oscillation circuit with the information and to use the corrected clock when the control unit performs the processing with electric power supplied from the internal power supply.
